(19) United States
(12) Patent Application Publication
(10) Pub. No.: US 2007/0055523 A1
(43) Pub. Date: Mar. 8, 2007

(54) Pronunciation training system

(76) Inventor: George L. Yang, Owings Mills, MD (US)

Correspondence Address: George L. Yang, 4628 Kings Mill Way, Owings Mills, MD, 21117, US

(21) Appl. No.: 11/211,931

(22) Filed: Aug. 25, 2005

(51) Int. Cl. G10L 15/18

(52) U.S. Cl. 704/257

(57) ABSTRACT

A pronunciation training system extracts pronunciation features from various pronunciation samples, links pronunciation features with corresponding muscle movements and diagram representations, displays related waveforms and pronunciation processes, and mark the differences between different waveforms and different pronunciation processes for helping a user to distinguish different sounds. First, the system collects pronunciation samples from people, categorizes these samples, analyzes them in time domain and in frequency domain, identifies the positions and movements of pronunciation organs, provides interfaces for experts to define pronunciation features, extracts and compares pronunciation features, and build links between pronunciation features and pronunciation processes. Then, the system collects pronunciation samples from a user, analyzes the pronunciation samples, extracts pronunciation features from the pronunciation samples, regenerates the pronunciation process, and displays related waveforms for helping a user to enhance the user's awareness on different sounds. The system can further increase the user's awareness on how a sound relates to a pronunciation feature and the muscle movements of a pronunciation organ by providing interfaces for a user to create different sounds by modifying the existing sounds on its loudness, tone, duration, and pace, by modifying the features in time domain or frequency domain, and by modifying the muscle movements of related pronunciation organs.

### TECHNICAL FIELD OF THE INVENTION

This invention relates generally to a system for helping people to improve the ability to discriminate different sounds and to produce correct sounds. Specifically, the invention illustrates a system for collecting pronunciation related samples, extracting features from these samples, identifying the muscle movements involved by various pronunciation organs, linking features with corresponding muscle movements, and displaying the muscle activities of pronunciation organs to produce a particular sound.

### BACKGROUND OF THE INVENTION

For various reasons, people want to learn other languages. As the transportation technology and information technology progress rapidly, people can easily gather from different portions of the world by airplanes and exchange ideas from anywhere in this world through telephone and Internet. Learning foreign languages is also one of the major ways for people in developing countries to learn advanced science and technology from developed countries. Due to this reason, many peoples especially those in developing countries spend tremendous hours to learn foreign languages. However, many people, especially adults, have difficulty to master the pronunciation skills required by an alien language. Numerous adults may have no chance to learn foreign languages in their childhood when they still have strong language learning capability. Even among those people who have obtained a chance to learn foreign languages when they are very young, not every one of them can have a desired environment to imitate standard pronunciations of a foreign language, have a native speaker trained to correct their pronunciation problems, and have opportunities to make conversation with any native speakers. Some of them may never speak in a foreign language even just a sentence in a real situation before they talk to a visa officer at a consulate or embassy of a foreign country. Even though they may pass foreign language tests with very high scores, once they enter a foreign country, they will realize that they cannot understand what other people say and other people cannot understand what they say too.

Besides learning a foreign language, people may want to add a particular accent to their pronunciations or remove a particular accent from their pronunciations for various purposes. One example is for an actor to add an accent of a particular region to his pronunciation. Further, some children have difficulty to pronounce some sounds correctly even in their own native languages. The teachers, parents, and doctors may reach conclusions that the pronunciation difficulties of these children are due to the problems with their tongues and other pronunciation organs or due to the ecstasy of love from parents. With the help of their parents and professionals, some children can gradually generate correct pronunciations. Nevertheless, this process usually takes a long time. Some children may improve their pronunciations a little bit but they will never be able to pronounce sounds up to society standards even though they become adults. For these adults, though they feel that they do pronounce in a way just as everyone else does and do hear their pronunciations sound exact as the pronunciations of other people in their society, the society still thinks that these adult's pronunciation are difficult to understand and wired.

Since what people hear about their own pronunciations are usually very different from what other people hear from the same pronunciations, people may have difficulty to master a pronunciation skill, add a particular accent to their pronunciations, and remove a particular accent from their pronunciations. Therefore, it is necessary to help people to generate desired pronunciations quickly and to make their pronunciations understandable.

Many materials, in forms of books, tapes, and CDs, are available to help people to improve their pronunciations and remove their accents from their pronunciations. Numerous software packages are also available to help people to make good pronunciations. In addition, some instruments and hearing aid devices are available to help people to hear weak sounds. However, as some pronunciation experts have realized, the key factor for people to make a good pronunciation on a foreign sound is to distinguish among foreign sounds and to distinguish between foreign sounds and native sounds. In facts, many people with pronunciation problems have no any difficulty at all to detect a tiny sound but they cannot distinguish some sounds that are very different according to a native listener. As discovered by scientists, people intend to filter away the foreign components in an alien language, assimilate foreign sounds by similar sounds in their native languages, and become less and less sensitive to foreign sounds as they become older. Some children have pronunciation problems because they do not hear the sounds that they are going to imitate correctly and therefore they imitate wrongly.

Due to above phenomena, people may think that there are no differences among some sounds of a foreign language, though a native speaker of that foreign language treats these sounds as totally different sounds. People may also find some sounds in a foreign language very strange and have difficulty to use correct pronunciation muscles to pronounce these sounds. Further, people may have difficulty to tell the differences between some sounds in a foreign language and the similar sounds in their native language. Sometimes even though people may have a vague sense that these sounds have some differences, they still cannot tell where the differences are.

Realizing the fundamental reason for some people to produce sounds incorrectly, some pronunciation professionals have developed a few tools to help their clients to realize the differences among different sounds. After having captured the verbal samples of people's pronunciations through microphones, these tools display the corresponding waveforms in time domain or their corresponding waveforms in frequency domain. Though these tools help people on their pronunciation somehow, they have some shortcomings. First, since these tools usually do not tell people directly about the information contained in these waveforms, it is their users' responsibility to find out useful information from these waveforms. Second, the waveforms in time domain for a sound may vary depending on the starting point of recording, the relative strength, interference, and other factors. Third, the waveforms in frequency domain may vary even more. Because the system creates the waveforms in frequency domain by performing Fourier transformation on the waveforms in time domain, waveforms in frequency domain depend on not only all the variations existed for the waveforms in time domain but also the length of time interval for performing Fourier transformation Therefore, these tools are useful only when there are professionals to read these waveforms, explain their meanings to people, make people understand what and where their pronunciation problems are, and teach people how to improve their pronunciations.

According to above discussions, it is desirable to provide a system to help people to distinguish different sounds, provide people necessary feedback, and guide people to improve their pronunciations. The system will capture a user's pronunciations, extract various pronunciation features, identify muscle movements of various pronunciation organs, link pronunciation features with corresponding muscle movements, display simulated pronunciation processes, indicate a user directly the pronunciation problems, mark the difference between a right pronunciation process and a wrong pronunciation process, and generate various voices with desired pronunciation features.

### OBJECTIVE OF THE INVENTION

The primary object of the invention is to provide a system to capture pronunciations, analyze pronunciations, extract pronunciation features, compare these features with those extracted from standard pronunciations, and display the differences between them.

An object of the invention is to provide a system to simulate a pronunciation process with desired features, which consists of the features extracted from pronunciation samples, the features modified from the extracted pronunciation features, or the pronunciation features created artificially.

Another object of the invention is to provide a system to show a pronunciation process from a particular direction or from a particular aspect by animating pictures.

Another object of the invention is to provide a system for a user to examine a pronunciation process from various aspects simultaneously.

Another object of the invention is to provide a system for a user to slow down a pronunciation process and check the pronunciation process from various aspects simultaneously or from one aspect then another aspect.

Another object of the invention is to provide a system for a user to specify and modify a pronunciation process to generate sounds with specific requirements on pronunciation organs and on volume, duration, pace, pitch, and intonation.

Another object of the invention is to provide a system to extract features from particular people and from people of particular areas, regions, and countries and to save these features into a database.

Another object of the invention is to provide a system for experts to provide training texts, to supply explanations and instructions for each predefined problem and for each predefined category of users, to assist a user to repeat pronunciation exercise from selected aspects, and to aid a user to practice differently at different stages.

Another object of the invention is to provide a system to pre-process a text, identify sounds, tones, syllables, and stresses, mark intonations, diagnose potential problems with a user or a group of users, pre-display the shape and movements of selected pronunciation organs, and remind a user of possible problems by oral prompts, written prompts, special symbols, written sentences, or different fonts.

Another object of the invention is to provide a system to identify the pronunciation features as well as the problems associated with a particular pronunciation with the pronunciations of a particular person, or with the pronunciations of people from a particular group.

Another object of the invention is to provide a system for a user to modify the feature identification utilities, apply these utilities to recognize the pronunciation features, and adjust the pronunciation features.

Another object of the invention is to provide a system to analyze pronunciations in both time domain and transform domain, to adjust waveforms by selecting starting point, scaling magnitude, and removing trivial parts, to emphasize major features, and to mark important issues.

Another object of the invention is to provide a system for a user to display different sounds in proper displaying schemes and compare these sounds from selected aspects.

Another object of the invention is to provide a system to show the differences between two sounds on selected aspects and ignore their differences in noncritical aspects.

An object of the invention is to provide a system for a user to specify, modify, and build algorithms and procedures for recognizing various pronunciation features, making comparisons, and creating representations.

Another object of the invention is to provide a system to generate artificial feedbacks to help a child, who has difficulty to hear some sounds clearly or has difficulty to produce some sounds correctly, to produce these sounds right with proper muscle movements.

Another object of the invention is to provide a system to help people with normal speaking capability but with defect hearing organs to sense the difference among different sounds and make better pronunciations.

### SUMMERY OF THE INVENTION

The system of the invention helps people to increase awareness of different sounds and therefore enhances people's capability to pronounce sounds correctly. First, the system of the invention takes pronunciation samples, extracts the pronunciation features from the pronunciation samples, identifies various muscle movements of pronunciation organs, links pronunciation features with corresponding muscle movements, shows one or more pronunciation organs from one or more aspects, recreates sound according to extracted pronunciation features, and saves various information into a pronunciation database. Second, the system of the invention preprocesses a text for practice, identifies various sounds in the text, marks the sounds, stresses, pitches, and intonations, anticipates possible pronunciation problems, reminds a user about his or her major pronunciation problems in various ways, and pre-displays the activities of some pronunciation organs. Third, the system of the invention rebuilds a pronunciation process and examines the pronunciation process by analyzing the features in pronunciation samples, capturing muscle movements, comparing these features with the ones saved in database, and making use of the relations between features and activities of various pronunciation organs. Forth, the system of the invention provides interfaces for a user to define a pronunciation process by specifying and adjusting pronunciation organs directly and by specifying and adjusting associated pronunciation features indirectly.

### BRIEF DESCRIPTION OF THE DRAWINGS

The drawing figures depict preferred embodiments of the present invention by way of example, not by way of limitations.

FIG. 1 illustrates the general environment for users, teachers, or experts to build a pronunciation database, which contains the pronunciation features for particular persons and for a particular group of people coming from a particular country, a particular region, or a particular area, and the comparisons among different persons and among people from different categories.

FIG. 2 illustrates a general flowchart to generate a database containing pronunciation features, muscle movements, and relations between muscle movement and pronunciation features for individuals and for a group of people as well as the reorganizations, comments, explanations, and instructions for various pronunciation problems.

FIG. 3 illustrates the general environment for users, teachers, or experts to apply various procedures predefined in the system to help themselves, their students, or their clients to identify pronunciation problems.

FIG. 4 illustrates a general flowchart for users, teachers, or experts to identify pronunciation problems for themselves, for their students, or for their clients. The system extracts pronunciation features, compares them with those of standard pronunciations, makes use of the relations between pronunciation features and muscle movements, simulates a pronunciation process, and provides interfaces for people to examine pronunciation from various aspects.

FIG. 5 illustrates a general flowchart for helping users to perform pronunciation exercises. The system loads the preference and setting of a user, sets up focus, determines the major pronunciation problems of a user, identifies sounds, syllables, and stresses in a text documents, marks the letters or words containing difficult sounds outstanding, gives hints, and provides instructions for how to pronounce a sound.

### DETAILED DESCRIPTION OF THE PREFFERED EMBODIMENTS

The system generally has two major portions. The first portion is to extract pronunciation features for individual persons, to find the common features among a group of persons from same countries, same regions, or same areas, to distinguish the pronunciation features among different people or people at different stages, to describe muscle movements of pronunciation organs, and to link pronunciation features with corresponding muscle movements. The second portion is to extract the pronunciation features from the captured information of a user, to compare them with the pronunciation features pre-saved in a database, to reconstruct a pronunciation process, to display the regenerated pronunciation process in slow, regular, or fast pace, to modify a pronunciation process by letting a user specifying pronunciation organ movements, pitches, speeds, volumes, durations, and tones, and to compare pronunciations from different aspects and in various diagrams.

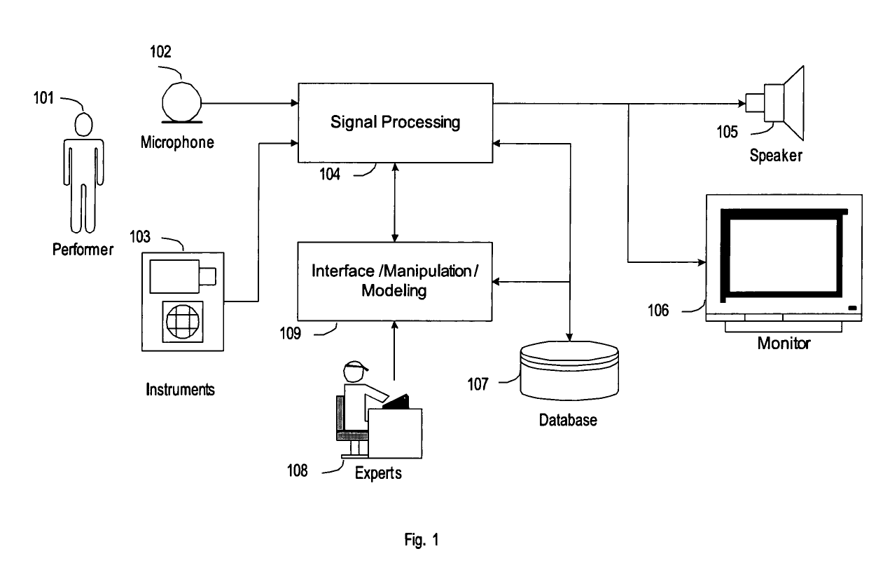

FIG. 1 shows the basic environment for collecting pronunciation samples, extracting pronunciation features, and building a pronunciation database. The system collects samples from performer 101. Here pronunciation features, or features for simplicity, refer to anything that can make a pronunciation different from another pronunciation or mark a difference between a pronunciation and another pronunciation. A pronunciation feature can be an attribute derived directly or indirectly and naturally or artificially, an attribute derived from verbal samples, non-verbal samples, or both, an attribute derived in a time domain or in a transform domain, or an attribute consisting of several sub-attributes.

The system determines what type of samples, what kind of people, how many samples, and what sample templates to use according to experts 108, specific requirements, or some criteria. An example of criteria is a confidential threshold for deciding how many samples the system should take in order to perform a statistical analysis with enough confidence. Experts can specify the templates of sentences, words, or sounds that the system will take samples from a person, or a group of persons. Here an expert can be a pronunciation professional, a speech professor, an accent reduction teacher, user him or herself, and even a software package. On one hand, the more samples the system takes from a person or from a group of persons, the more information the system can extract from these samples, and the more confidence the system can have on the information extracted from these samples. On other hand, not only it takes time to find proper persons and collect samples from them, but also it could take a lot of computer time to process the collected information and a lot of computer memory to save information. A tradeoff could let experts to specify what kind of people to select and to specify what sample templates to use and let the system to determine how many samples to take according to a pre-selected confidential level.

The system provides interfaces for experts 108 to modify the data saved in the database 107. The experts 108 can override a decision made by the processing module 104, add some features, remove some features, emphasize some features, or simplify some features. The experts 108 can also tell the system to use a specific procedure when there is more than one procedure in the processing module 104 to choose for performing a particular function. The experts 108 can further specify some parameters for a procedure in module 104 when there are some parameters need to specify for the procedure.

A pronunciation process consists of numerous voice and non-voice related actions. The system gathers verbal samples through the microphone 102 and non-verbal samples through instruments 103 such as camera and sensor. These non-verbal samples usually relate to verbal samples in some ways. For example, a professional speaker may use abdominal muscle movement to control the volume of his or her pronunciation. For simplicity, both verbal samples and non-verbal samples will be referred as pronunciation samples, or samples for short.

The system can use various instruments to capture various non-verbal samples. One type of the very important non-verbal samples is the facial expression of a performer. To grab the facial expression, the system can employ cameras, camcorders, or any video recorders. The system can also derive the movement of pronunciation organs inside a mouth according to the relations between the facial expression as well as verbal samples and the movements of various pronunciation organs. The system can further identify the movement of pronunciation organs inside a mouth directly by resorting to some instruments that can create image invisible or difficult to see by human fresh eyes from outside. For example, the system can deploy various instruments built according to principles of ultrasound, infrared ray, and other mechanisms to penetrate mouth for generating images of pronunciation organs. Among all the pronunciation organs, tongue is the very most important organ in producing a sound.

Besides muscle movements and facial expressions, the system can capture other important aspects of a pronunciation process through instruments built specially for each particular purpose. Some examples are the airflow path, air strength heart beat rate, and body temperature.

By executing various pre-built procedures, the system can process the collected information, generate useful information, reduce noise, remove interference, simplify waveforms, identify pronunciation features, and generate various parameters. These procedures simulate how experts will process information, make decisions, and handle various cases. For instance, the system can display waveforms in time domain and in frequency domain, show the shapes, positions, and movements of a tongue at different moments, and exhibit the parameters for various pronunciation models. Here a pronunciation model refers to any one built from available technologies for regenerating a sound, displaying a pronunciation process, and illustrating the differences between two pronunciations.

One can build a pronunciation model according to linguistics, phonetics, phonology, physiology, psychology, biology, acoustics, voice source dynamics, phonetic interpretation, artificial intelligence, bioelectronics, pattern recognition, etc. One can sort a pronunciation model according to many different categories such as electronic-based or physical-based, stationary or non-stationary spectral, audio or visual, tree-based or not.

The system provides proper interfaces for experts 108 to specify new features and modify existing features associating to a particular pronunciation. For example, experts 108 can specify the shape, the initial position, and the movement of a tongue instead of using the ones captured by an instrument or derived by predefined procedures.

The system creates sounds through speaker 105 by replaying the captured sounds, by modifying the captured sounds and then replaying, by generating artificial sounds according to some pronunciation models.

The system displays various diagrams through the monitor 106. The system can display a pronunciation process as seen from front, from side, from inside out, and from a penetrating instrument. The system can also display a pronunciation process in a regular, slow, or rapid mode. The system can further display a pronunciation process with some pronunciation organs ignored, with some pronunciation organs emphasized, and with important features focused.

The system can display a pronunciation process and its related information in many different ways. For example, the system can show the position, shape, and movement of one or more pronunciation organs directly or indirectly; the system can show the movements of several pronunciation organs one by one or simultaneously; the system can show the movements of a particular pronunciation organ with other pronunciation organs ignored; the system can show a particular pronunciation organ or several pronunciation organs from a particular viewing direction or several different viewing directions; and the system can show other features such as air flow and its strength. Instead of showing a pronunciation organ or pronunciation organs directly, the system can use convenient symbols or icons to represent each pronunciation organ respectively with or without any assistant marks. For example, the system can show the movements of tongue by symbolizing a tongue as an icon and refer tongue's positions by placing the icon at a corresponding place in a reference diagram. Moreover, the system can display waveforms and analytical data extracted from pronunciation samples. The simplest waveform is the one recorded by the system through the microphone 102. The system can also display waveforms with waveforms simplified and interference removed, or with particular features identified and marked. Besides the waveforms in time domain, the system can display the waveforms in any transform domain such as frequency domain through Fourier analysis or wavelet transform. In addition, the system can display the information derived from pronunciation samples through various statistical techniques and pattern analysis techniques.

The database 107 is to save the pronunciation samples, their analysis results, and other information The database 107 can use various database technologies for searching, saving, inquiring, reporting, creating forms, generating table, creating macros, and creating modules. The database 107 can include pronunciation samples, the extracted features from the pronunciation samples, the corresponding activities of pronunciation organs, the comparisons among the pronunciation features, various pronunciation problems and their identification, comments, explanations, instructions, training materials, the parameters for selected pronunciation models, and other analysis results.

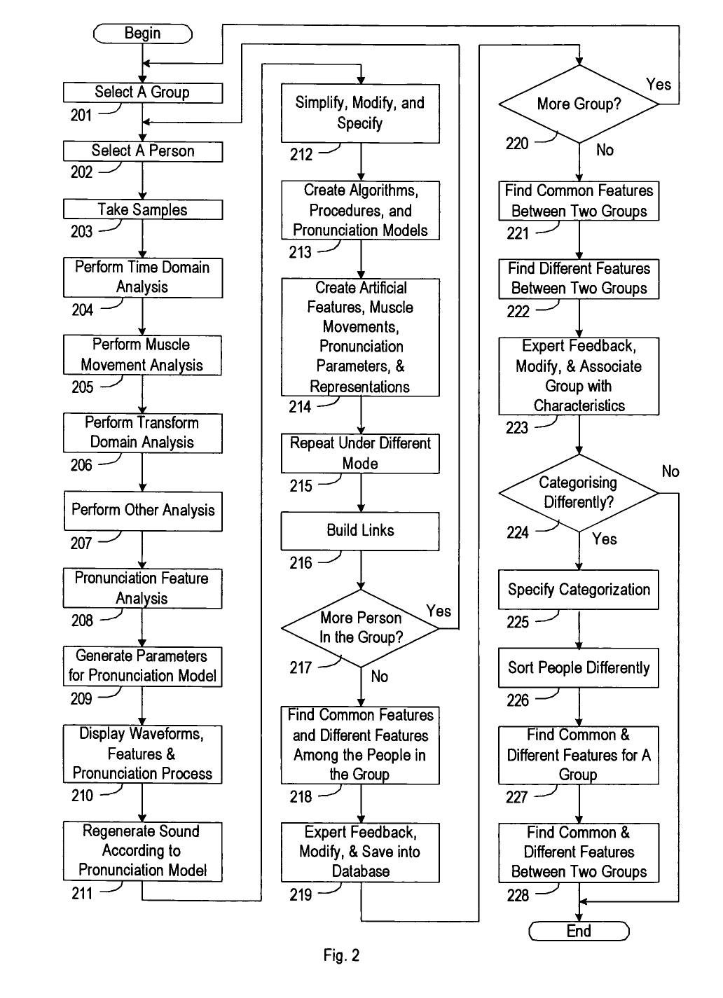

FIG. 2 shows an exemplary flowchart of building a database containing pronunciation samples, the features of these pronunciation samples, and the comparison among these features. First, the system takes pronunciation samples from a same person under different scenarios and from people from a same area, a same region, or a same country. Then, the system analyzes the features from these pronunciation samples, identifies various muscle movements of pronunciation organs, and categorizes these features and movements by various techniques such as pattern recognitions in time domain and in transform domains. Further, the system builds links among pronunciation features and corresponding muscle movements. In addition, the system provides interfaces for experts to modify features, create variations, generate comments, provide instructions, adjust links, display waveforms, and process other information.

At step 201, the system provides interfaces for experts to specify a group of people from them that the system will take pronunciation samples. A group of people is people from a same country, a same region, a same area, a same race, or some combinations. The people of a same group usually have some common pronunciation habits and therefore may bear some common pronunciation features.

At step 202, the system provides interfaces for experts to specify a person from whom the system will take the pronunciation samples. Usually experts want that the pronunciation samples to take from the people are able to represent the general speaking habits of a particular person or people in a particular group.

At step 203, the system takes samples from the person selected at step 202. The most important samples are verbal samples from the person. Besides the verbal samples, the system can also collect non-verbal samples accompanying with the verbal samples. One example of non-verbal samples is facial expressions and another example is tongue's movements. The system can collect pronunciation samples, which include verbal samples and non-verbal samples, according to a single sound, a word, a phase, or a sentence. The system relies on sample templates to determine which sounds, words, phrases, sentences to use for collecting pronunciation samples from a particular person or a particular group of person A simple sample template can be a list consisting of a sequence of sounds, words, or sentences that can reflect the pronunciation habits of particular person or a particular group. To improve recording quality, the system can further deploy some algorithms to cancel interferences and reduce noises.

At step 204, the system performs time domain analysis on the recorded pronunciation samples according to some predefined procedures. These procedures simulate the process of how experts identify pronunciation features and how experts quantify pronunciation features in time domain. By imitating experts, the system can extract a lot of information directly from verbal samples and non-verbal samples in time domain. For example, the system can obtain average volume and duration from verbal samples and obtain the information about which muscle used by a person to pronounce a specific sound from facial expressions.

At step 205, the system performs various muscle movement analyses, which includes identifying the tongue's position, shape and movement. The system has procedures to simulate various processes of how experts identify and quantify the muscle movements and the pronunciation features through pattern match techniques and pattern recognition techniques. By applying these procedures on the information captured from instruments such as cameras and ultrasonic equipment, the system will identify muscle movements of pronunciation organs.

At step 206, the system extracts the pronunciation features from the captured pronunciation samples in one or more transform domains. First, the system performs predetermined transforms on the captured pronunciation samples to obtain transformed samples. Then, the system identifies the pronunciation features from the transformed samples in each of the transform domains by executing procedures that simulate how experts identify and quantify pronunciation features in each transform domain. Sometimes one can easily recognize some features in a transform domain, which are difficult to identify in time domain or in original recording domain. A very important and commonly used transforming technique is the fast Fourier transform. Another very important transforming technique is wavelet transform.

At step 207, the system performs other analysis on the captured samples by various technologies. These analyses can be in time domain, in original domain, or in any transform domain. One instance of the technologies is statistic analysis. The statistic analysis is to find the statistical relations among various samples and among various features. A very important statistical analysis is the correlation analysis to find the correlation value between a feature and a particular person, the correlation value between a feature and a group of people, and the correlation value between a feature and a particular sound, a particular word, or a particular sentence. Another example of the technologies is assistant information analysis, which is to make use of side information such as history, previous results, and preference settings to search for specific information or aid in making a decision.

The system analyzes the pronunciation samples by using various techniques such as voice epoch determination, speech signals decomposed into deterministic and stochastic components, speech signals decomposed into periodic and a periodic components, ceptrum-based techniques, back-propagation learning, and multi-class induction learning.

At step 208, the system identifies the pronunciation features jointly from the results of time domain analysis, muscle movement analysis, transform domain analysis, and other analysis. One may define some features in one or more domains. A feature in a domain may relate to another feature in a different domain. The system can analyze the relations especially the correlations among different features by using various technologies, describe a pronunciation feature from one or more attributes and in one or more categories, and make a joint decision by making use of the information in various domains according to predefined procedures. These procedures simulate how experts make joint decisions.

At step 209, after identifying the pronunciation features, the system generates parameters for various pronunciation models. A pronunciation model can be a model that simulates human pronunciation organs directly or indirectly, from different aspects, with different approaches, and at different levels. Depending on implementation, a pronunciation model can be simple or complex. One can build a simple pronunciation model according to one or more techniques in speech synthesis. One can also build a complex pronunciation model according to physiology. For each selected pronunciation model, the system generates corresponding parameters according to corresponding predefined procedures that describe the relations between pronunciation features and parameters of that model According to these parameters as well as contents contained in pronunciation samples, the system creates sounds through one of corresponding pronunciation models and reconstructs a pronunciation process. Though some features and some parameters may look similar in some case, generally a parameter associates with a particular pronunciation model. For example, the loudness of pronunciation may refer as a feature. If a pronunciation model is to simulate pronunciation organs directly, the feature of loudness may transfer to the strength of airflow or the movement of abdominal muscles. If a pronunciation model is to simulate a pronunciation process indirectly by such as a finite input response filter, the feature of loudness may transfer to the input strength of the filter.

Besides pronunciation models, the system can also provide hearing models for helping people to distinguish internal hearing and external hearing. The internal hearing is what one heard on one's own voice through internal channel and the external hearing is what other people heard on someone else's voice through external sound transferring path The internal hearing may differ from the external hearing very much First, experts can simulate the sounds entering other people's ears by recording one's own sounds on high fidelity recording devices through high fidelity microphones and then playing back through high fidelity audio players. With proper arrangement of audio players, the feelings of people about various sound related attributes on what heard from the high fidelity audio player and on what heard directly from a person's mouth are the same or very close. Then, experts can build a hearing model to simulate the internal sound transferring process according to ear structure, internal sound transferring path, etc. Depending on simulation requirements, one can implement a hearing model with different complexities. A hearing model can be a simple algorithm with some parameters adjusted for different people or for same people under different scenarios. A hearing model can be a complex algorithm with some parameters varying with the time. One can implement a simple algorithm by a time-invariant hardware filter, a time- invariant software filter, or a piece of code with fixed parameters. One can also implement a complex algorithm by time-variant hardware filter, time-variant software filter, and a piece of code with variant parameters. By listening to the simulated internal sounds generated through a hearing model with the recorded sound as input, experts can adjust various parameters, both time-invariant and time-variant, to make the simulated internal sounds close to what expert heard on one's own sounds through internal sound transmission path.

There can be other hearing models to convey the sounds heard internally to what other people heard externally. The system can provide interfaces for experts to improve hearing models, to build specific hearing models for a specific person or specific category of people, and to collect more information about parameters of a hearing model for people of various areas, regions, countries, race, sex, nationality, etc.

With these hearing models, the system can process various sounds, display related waveforms from either internal side or external side, and further help people to distinguish different sounds.

At step 210, the system displays the recorded waveforms, the transformed waveforms, the features identified from waveforms or pronunciation samples in various domains, as well as the pronunciation process. Depending on setting, the system displays some or all related diagrams. The system can display them simultaneously, one by one, in regular speed, slow fashions or rapid mode. The system can also mark some features for emphasis. The system can further provide verbal or text explanation for some features that are pre-documented.

At step 211, the system creates sounds according to various pronunciation models and corresponding pronunciation parameters. The system can provide interfaces for experts to specify and modify pronunciation parameters. The system can further make various analyses to extract features from the regenerated sounds in time domain and in some transform domains. By hearing the regenerated sounds and examining the regenerated features, experts can judge if the parameters reflect the pronunciation features that the expert has recognized, if it is necessary to improve a pronunciation model, if it is critical to update a related procedure, etc.

At step 212, the system simplifies the waveforms in time domain and in transform domains, emphasizes the major features, ignore trivial portions, and reduce redundant information according to the procedures predefined for each of these purposes. The system can also provide interfaces for experts to specify and change features, to modify diagrams, to alter the movement of pronunciation organs, to change waveforms, and to adjust reference points, marks, or labels on waveforms.

The procedures for identifying various features may not be perfect especially at the beginning of early stage of the system development. First, the experts define features, design procedures to analyze pronunciation samples, find out various features, and rebuild the movements of pronunciation organs. Then the system displays corresponding results so that experts can verify these results, identify where the problems are, and simplify, modify, or specify corresponding procedures. Since this process generally involves test and trial it takes time for a procedure to become mature. The system provides experts necessary opportunity to modify procedures.

The system not only provides interfaces for experts to modify various procedures, but also provides interfaces for experts to view various diagrams and modify various features. The system can provide interfaces for experts to specify and modify shapes and movements of various pronunciation organs. The system can also provide interfaces for experts to specify other features that human eyes cannot see directly such as airflow. In addition, the system can provide interfaces for experts to specify and modify pronunciation features. The system can further provide interfaces for experts to display the waveforms and the pronunciation organ movements. Instead of modifying procedures, at this step, the system can provide interface for experts to modify various results directly.

At step 213, the system provides interfaces for experts to implement algorithms and develop procedures for identifying and simplifying various features, for generating parameters of various models, and for building various models. Besides the regular interfaces for editing, compiling, or explaining a program, the system can supply interfaces for testing the procedures, algorithms, pronunciation models, etc. The system can have necessary platforms or call third-part utilities for experts to design, debug, and test various procedures and models.

At step 214, the system provides interfaces for experts to create artificial features, specify muscle movements, set pronunciation parameters, and select displaying formats. Sometimes experts may want to add some artificial features and alter muscle movements for some special purposes such as testing and sometimes experts may want to display a waveform, mark a feature, or present a pronunciation process in specific ways.

At step 215, the system repeats the process of taking pronunciation samples and performing analysis for the person selected at step 202 or the group selected at step 201 under different modes. The pronunciation samples from a same person or a same group of people under different modes could be different. For example, the sound for a same sentence said by a same person under normal situation, laughing, crying, angry, and other emotional cases can be very different. Depending on implementation, there can be some boundary or gradual transformation among different modes. By analyzing the pronunciation samples under different modes, the system finds the common features and different features of a particular person or a particular group of people under different modes.

At step 216, the system builds links among various features, pronunciation samples, procedures, algorithms, representation methods, models, parameters, etc according to preference settings, predefined procedures, and specific requirements. The system can also provide interfaces for experts to modify the links created automatically and specify new links. For example, experts may prefer to illustrate a pronunciation process by a particular display method. By setting the displaying format of a pronunciation process to a particular display method, experts tell the system to link that pronunciation process to that particular display method. To help a user to identify pronunciation problems, the system can provide interfaces for experts to specify pronunciation feature deviations, quantify pronunciation features deviations, link pronunciation features and their deviations to corresponding pronunciation problems, associate pronunciation problems to corresponding variations of muscle movements, corresponding variations of waveforms, corresponding explanations, corresponding instruction for making improvements, and corresponding hints. The system can have a set of predefined procedures to do these tasks automatically. These procedures imitate how experts are going to process and build links.

At step 217, the system provides interfaces for experts to indicate if there are more people in the group specified at step 201. If yes, go to step 202 and otherwise, go to step 218.

At step 218, the system finds the common features and different features among the people in a same group by using various techniques. There can be many categories to sort the pronunciation features. For example, experts can sort a feature according to if the feature relates to description of the movement of a particular pronunciation organ The system can use the differences among the features in a same group to create varieties of pronunciations among the same group. Instead providing a clear boundary among common features and different features, the system can provide interface for expert to define the similarities among pronunciation features of the people in a same group according to fuzzy mathematics.

At step 219, the system displays the results and provides interfaces for experts to generate feedback and modify, specify, and save results. At this step, the system lets experts to make the ultimate decisions. An intelligent system, especially at its early stage, may not be able to recognize all the features correctly. In this case, the experts may want to make corrections by modifying features directly or modifying related procedures to modify results indirectly. Further, experts may want to create some artificial features. Through proper interfaces, experts may create new features from scratch or modify some ones existing in the system There can be predefined procedures to accomplish these tasks automatically by imitating how experts make modifications.

At step 220, the system checks that if experts want to consider more groups. If yes, go to step 201 to select next group and repeat the steps 202 to 219. Otherwise, go to step 221.

At step 221, the system finds the common features between two groups among all possible or selected group pairs by applying various technologies. Some technologies may directly relate to pronunciation organs and some technologies may indirectly relate to pronunciation organs. A very useful technique is statistical analysis.

At step 222, the system finds the different features between two groups of all possible or selected group pairs by applying various technologies.

The system can do steps 221 and 222 together. The system can find he common features or different features according to some thresholds predefined. Instead of providing a binary judgment, the system can also make a judgment by creating fuzzy boundaries according to probabilities, likelihoods, correlations, fuzzy concepts, and fuzzy logics and by assigning different certainties for different decision zones.

At step 223, the system displays the common and different features between two groups of all possible or selected group pairs and provides interfaces for experts to modify the likelihoods of features and specify common features and different features. The system can also provide interfaces for experts to create some features and to emphasize particular pronunciation characteristics. The system can further provide interfaces for experts to group features, combine features, and split features.

At step 224, the system checks if experts want to categorize differently. If yes, go to step 225 and otherwise end.

At step 225, the system provides interface for experts to define new categories. For various reasons, sometimes experts may want to sort a person into several categories.

At step 226, the system separates people into different categories according to the new defined categories. By sorting people differently and using various correlation analysis technologies, the system may find the relations among the pronunciations of people that do not relate noticeably.

At step 227, the system finds the common features and different features among the people in a same group according to each of the new categories.

At step 228, the system finds the common features and different features between two groups of all possible or selected group pairs for each of the new categories.

The system can save useful information into its database. The information could include pronunciation features, muscle movements, relations between pronunciation features and muscle movements, presentation diagrams, pronunciation feature deviations, pronunciation problems, comments, explanation, instructions, indication symbols, pronunciation models, and various procedures. Though the system has a set of pre-built procedures to perform particular functions predefined, the system can also provide proper interfaces for users or experts to build new procedures, modify existing procedures, and replace old procedures.

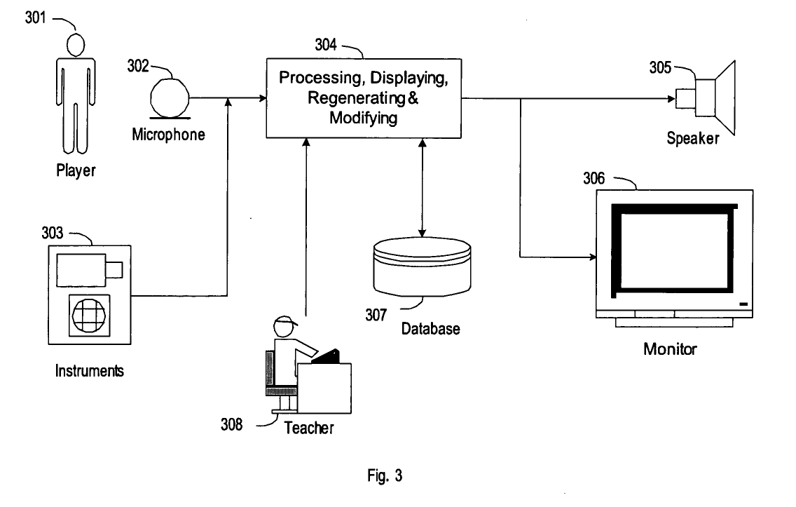

FIG. 3 shows the basic environment for identifying pronunciation features, comparing features with the ones saved in the system, and displaying their differences. The system collects pronunciation samples from the player 301 through microphone 302 and capture facial, body, and other information through instruments 303 such as cameras, camcorders, and sensors. The player 301 can be user him or herself, a student, or a client. The system has numerous predefined procedures for processing, displaying, regenerating, and modifying information, as shown in the block of 304. The system processes the information captured through microphone 302 and instruments 303 according to the related procedures and information saved in the system. The system generates sound through the speaker 305 and displays the results through the monitor 306. The user, expert, or teacher 308 can modify the procedures and results, set up options, and adjust parameters as well as the information saved in system Depending on setting, the system can display player's pronunciation features in time domain, frequency domain, or other transform domain, create sounds through corresponding pronunciation models, illustrate player's pronunciation process, show player's pronunciation progress, compare difference among a desired pronunciation process, an actual pronunciation process, and an artificial pronunciation process. Also according to setting, the system can display a waveform, a feature, or a pronunciation process in one or more formats simultaneously or one by one, recreate sounds in normal speed, slow fashion, or fast mode. User, expert, or teacher can modify parameters of a pronunciation model, change muscle movements of pronunciation organs, or specify tone, speed, duration, and volume.

The database 307 includes the information provided by experts when building a pronunciation database and the customer specific information such as history, preference, focus, performer's pronunciation samples, and analysis results. The database 307 can use various database technologies for searching, saving, inquiring, reporting, creating forms, generating table, creating macros, and creating modules. Regarding to implementation, the database 307 usually consists of original system database 107 and one or more customer databases.

The player 301 and the teacher 308 could be different persons as in the scenario of a teacher helping his or her student and as in the scenario of an expert helping his or her client. They can also be a same person as in the scenario of a user teaching himself or herself.

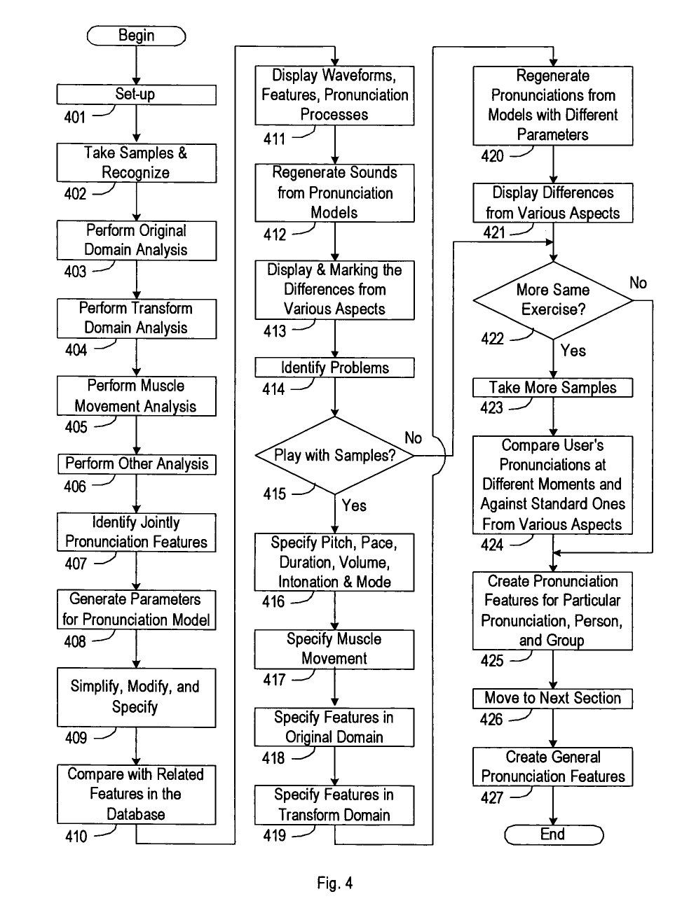

FIG. 4 shows an exemplary flowchart of applying the information in a pronunciation database in one's pronunciation exercise. There are several functions. First, the system captures user's pronunciation, analyzes them, displays results, and compares them with the ones saved in database. Second, the system lets a user play around to obtain some senses on how the voice will change by modifying related parameters and adjusting pronunciation process. The system provides interfaces for a user to specify pitch, pace, duration, volume, intonation, and mode, specify muscle movements of pronunciation organs, and specify pronunciation features in original domain or in a transform domain, and then the system regenerates pronunciations and displays the difference among the pronunciations with different parameters. Third, the system provides interfaces for a user to examine one's pronunciation from various aspects and hear what other people heard on one's voice. The system can also display a pronunciation process directly from facial expressions and muscle movements captured by the instruments associated with the system or indirectly by making use of the correlations between the pronunciation features extracted from pronunciation samples and those saved in its database.

At step 401, the system provides interfaces for a user to set up various preferences. The user can set up the sampling rate, if applying interference canceling technique, if applying background noise reducing technique, etc. The user can also specify which diagrams to use and which key issues to focus. Among several pronunciation exercise schemes with each scheme focusing on different issues, the user can further specify which one to use. Different users may have difficulties on different pronunciation aspects, need focus on different issues, prefer different display methods, choose different ways to make comparison, and want to have different practice arrangements. Even a same user, during different pronunciation practice stages, may prefer different ways to exercise for more efficiency. For example, when a user just learns a foreign sound, the user may want to watch the pronunciation of the sound from different aspects and the user may want to examine its waveform in time domain or in some transformed domain with major features emphasized. After some period, the user may have mastered the pronunciation skill already, but occasionally the user may make small mistake. In this scenario, the user may just want the system to remind him or her about the possible mistakes that the user may generate. Depending on settings, the system will let experts or teachers to involve more or less.

At step 402, the system captures the pronunciation samples from a user, which includes both verbal samples and non-verbal samples. Depending on setting, the system can perform various pre-processes such as simplifying pronunciation, canceling interference, and reducing background noise before recording the pronunciation samples on a recording device. The system can also recognize the sounds, words, and sentences according to various techniques as well as preferences, history, and training requirements. The system can further identify the captured sounds and recover corresponding sounds, words, and sentences by using various speech to word conveying technologies. For achieving better effects, the system can use side information such as the pronunciation features of a person, the common features of a group, and the training samples. Since the correctly identifying sounds, the correctly identifying words, and correctly identifying features relate to each other, instead of following a straightforward approach, the system can deploy an interactive approach to improve the probability of correct recognitions. For example, the system can further recognize sounds, words, and sentences after the system has identified various features.

At step 403, by following various predefined procedures, the system analyzes the pronunciation samples to find their features in the original domain. The system can also quantify each feature. After extracting the pronunciation features from the pronunciation samples, the system compares them with those ones in database. The system can further perform specific analysis in original domain to meet the specific need according to the procedure predefined for a particular user or a particular group of users.

At step 404, the system performs transformation on the pronunciation samples, generates transformed pronunciation samples, and then identifies the pronunciation features in one or more transform domains. For some features, it may be easier to identify them in a transform domain than in original domain. A very important transform is Fourier transformation and its variations such as fast Fourier transform, which reduces the number of multiplications and additions in discrete Fourier transform, and wavelet transform, which analyzes the characteristics in frequency domain with limited samples. A transform domain can be one dimensional, two dimensional, three dimensional, or even higher dimensional.

At step 405, the system analyzes the muscle movements of the pronunciation organs. The system can use various pattern match and recognition techniques to analyze the activities of facial muscles directly from the images captured by cameras or camcorders and the system can also derive the activities of pronunciation organs indirectly according to the identified pronunciation features and the relations between muscle movements and pronunciation features in original domain or transform domain.

At step 406, the system performs other analysis on pronunciation samples according to various technologies such as statistic analysis and assistant information analysis. The system can do these analyses in time domain, in original domain, or in any transform domain.

At step 407, the system identifies various pronunciation features and muscle movements. The system can obtain some of them directly and some of them according to the joint decision from various features identified at previous steps. Sometimes it is more reasonable or have higher confidence to judge if a feature exists and to what degree the feature exists from several aspects simultaneously. The system can derive other features from the results obtained in previous three steps and the relations among the pronunciation features in time domain, the pronunciation features in frequency domain, and the muscle movements. Besides the information directly derived from an analysis, the system can also derive some information from several analyses, from different sensors, and from information saved in the system. For example, the system can analyzes pronunciation samples and provides likelihood on if a person is in tense. However, if both the information captured by camera and heart beat rate sensor suggests that person is in tense, then the system can tell with a higher likelihood that a person is in tense. The system can have many predefined procedures for identifying various features, for identifying particular features, and for particular person or a particular group of people. In addition, the system can extract the modes about a user such as if the user laughs, cries, or is in anger according to predefined procedures from one or more aspects.

At step 408, the system generates the parameters for various pronunciation models selected previously or automatically selected according to the features identified. There can be pronunciation models simulating people's pronunciation process with more or less complexity and simulating at different layers. The pronunciation model can simulate the movements of pronunciation organs in two or three dimensions, or just generate sounds according to pronunciation parameters without directly involving pronunciation organs.

Besides pronunciation models, the system can load a particular hearing model and corresponding hearing parameters for a particular user from its database. Through the hearing model, the system can simulate the waveforms that represent the internal sounds heard by a user through internal path and provide interfaces for a user to compare the waveforms of these simulated sounds and their features.

At step 409, the system simplifies samples, modifies samples, and emphasizes pronunciation features according to some predefined procedures. The system can also provide interfaces for a user to simplify and modify the waveforms or features manually, specify a particular procedure, or define a new procedure. Through proper interfaces provided by the system, a user can create artificial samples by specifying the samples directly and by modifying some samples in database. At this step, the system provides opportunity for a user to correct any mistake that the system could make when the system is on its early version, the system is under training, or the system has no enough information about the person under analysis.

At step 410, the system compares various extracted features with the ones in database. Through the comparisons, the system can further derive information about the player, such as the muscle movement of pronunciation organs when generating a particular sound.

At step 411, the system displays the waveforms, various features, and pronunciation processes. The system can display original waveforms captured by microphones and various instruments, their transformed waveforms in one or more transform domains, and corresponding muscle movements. The system can also display the waveforms or diagrams related to one aspect of a pronunciation process one at a time or display all the waveforms and diagrams related to one or more aspects of pronunciation process simultaneously. In addition, the system can display a feature from one or several aspects and the system can display one by one or all the selected features simultaneously. When displaying a pronunciation process, the system can display the pronunciation process from one particular position such as from the front of the player, from one position then to another one, or from several positions simultaneously. The system can display a pronunciation process simulated to the real one, a pronunciation process viewed inside the mouth, or a pronunciation process with portion of face removed. The system can further display some invisible features such as the air strength by using an arrow with different sizes, different weights, or different colors standing for different airflow strengths. Moreover, the system can provide interfaces for a user to change the speed of a pronunciation, zoom into, zoom out, view from a different aspect, and check from several aspects simultaneously to examine a particular feature.

Besides displaying the muscle movements of each pronunciation organ, the system can also display the facial expressions for conveying more visual information according to articulator model and the relation between features and facial muscle movements.

The system can display a pronunciation process by numerous ways. The system can build a pronunciation model to reconstruct various pronunciation organs and their activities. Then, according to the muscle movements of various pronunciation organs and viewing directions, the system display a pronunciation process from many different aspects. The system can also display a pronunciation process according to one or several predefined directions, predetermined requirements, and predetermined relations between features and corresponding images without rebuilding a pronunciation model.

At step 412, the system regenerates the sounds according to the parameters and corresponding pronunciation models. The system can generate sounds by replaying the recorded verbal samples, by modifying existing verbal samples, and by changing various features to see how sounds will change. By providing different sounds, corresponding waveforms, and related diagrams, the system creates artificial feedback, helps a user to establish connections among sounds, waveforms, and movements, and therefore enhances user's capability to distinguish different sounds.

The system can also display waveforms and features extracted from the simulated internal sounds through hearing models and provide opportunity for a user to compare two different sounds not only by subjective feeling but also by objective waveforms and features.

At step 413, the system displays the differences among the sounds, the previous ones, the ones in database, or the standard ones from various aspects. After aligning them properly according to some criteria, the system can mark their differences by displaying them by different colors, different line patterns, and different symbols. Besides marking the difference among different sounds, the system can also provide voice or text explanations, which are in database for explaining the differences of various features. The system can display the differences in an original domain, one or more transform domains, or both original domains and several transform domains. Depending on settings, the system may just compare the sounds under certain categories, for a particular group, or for a particular person.

At step 414, the system identifies the pronunciation problems by comparing the features with the ones saved in database according to various predefined procedures specifically for identifying pronunciation problems. After finding out the difference between two pronunciations, the system can implement some procedures specifically designed for identifying the reason of generating the difference and then point out how a player should use his or her pronunciation organs to pronounce a sound correctly or add a particular accent for a particular purpose. The system can further launch related procedures for guiding a player to generate particular sounds, words, or sentences.

The system can repeat the steps 411 to 414 as many as a user prefers for identifying sounds, words, and sentences and the features associating with them. On one hand, with correctly identifying the sounds, the words, and the sentences, the system can identify the various features such as the mode of a player with higher confidential probability. On another hand, after the system has identified the features such as mode associating with the player, the system has higher probability to identify the sounds, the words, and the sentences. This can be an iterative process with each new iteration having more certainty on features and more certainty on sounds, words, and sentences.

At step 415, the system checks that if a user wants to play with the samples. If yes, go to step 416 and otherwise, go to step 422. By providing interfaces for a user to play with the samples, the system can help a user to compare sounds, examine from various aspects, and watch corresponding pronunciation processes.

At step 416, the system provides interfaces for a user to specify pitch, volume, duration, pace, intonation, stress, reduce sound, linking sound, and mode. According to user's specification, the system will generate new pronunciation samples accordingly by following some predefined procedures. The system can also provide interfaces for a user to modify directly pronunciation samples.

At step 417, the system provides interfaces for a user to specify muscle movement of various pronunciation organs. These muscles usually include tongue and lips. The system can further check chest muscle, abdominal muscle, and their movements. For example, the system provides interfaces for a user to specify the shape, positions, and movements of tongue, to specify the shape and the movements of lips, and to specify position and movement of teeth There can be natural restrictions on the degree that one can modify the movements of pronunciation organs and natural restrictions on the relations among pronunciation organs.

At step 418, the system provides interfaces for a user to specify various features and degree of each feature in original domain. The original domain can be time domain, two-dimensional domain plus time domain, or three-dimensional domain plus time domain.

At step 419, the system provides interfaces for a user to specify various features in transform domains. A transform domain can be a frequency domain, a wavelet domain, or a 2-D or 3-D transform domain.

At step 420, the system regenerates pronunciations for selected pronunciation models with corresponding parameters. The system obtain these parameters by following some predefined procedures, which calculate parameters according to the pronunciation models used, the identified features, the specified features, the modified features, and the defined muscle movements.

At step 421, the system displays the differences among the pronunciation samples, the standard pronunciation samples, and the modified pronunciation samples from various aspects. Through this process, the system can help a user to link the differences among different pronunciations to the differences among the positions and movements of related pronunciation organs and therefore enhance user's sensitivity on pronunciation features. The system can also display the simulated or reconstructed pronunciation processes from different aspects. The system can display the pronunciation organs'movement from different aspects and directions, with all organs presented or just one of the major organs presented. The system can display several diagrams simultaneously or display one diagram by another. Instead of displaying pronunciation organs directly, the system can display their symbolic representatives for simplicity or for emphasis. The system can further display waveforms in time domain or in a transformed domain with or without major features marked. In addition, the system can display the difference among different pronunciations by various diagrams and waveforms with or without oral or written explanations.

At step 422, the system checks that if a user wants to do more exercise on the same sound, word, and sentence. If yes, go to step 423 and otherwise, go to step 425.

At step 423, the system takes more pronunciation samples from the player and performs the same processing done on previous samples. The system can call predefined procedures to do various statistical analyses on these samples. According to the settings, the system can use all of these samples or just some of them for statistical analysis. The system can use the results from the statistical analysis to identify a particular user, simulate the pronunciation features of a particular user, and describe statistically more accurately the pronunciation features of a particular user.

At step 424, the system compares the pronunciations of a user at different moments and compares them with the standard ones in database, mark the differences, and indicate the improvements. The system can also provide text or verbal instruction on what progress the user has made and on how to make further improvements according to predefined procedures. The system compares user's pronunciations at two different trials and compares user's pronunciation with standard pronunciation from various aspects.

At step 425, the system generates the pronunciation features on the selected pronunciation samples for particular pronunciations, particular users, or particular group of users. These pronunciation features reflect the characteristic of a user on pronouncing particular sound, word, and sentence. The system can use these features to identify a particular user, people from a same area, same region, or same country. The system can also provide interfaces for a user to modify and specify the pronunciation features for a particular user or a particular group of users.

At step 426, the system checks that if a user wants to move the next session, which is similar to the current session except to work on different sound, word, or sentence. Continue the process until the user has done all sessions that the user wants to practice.

At step 427, the system creates more general pronunciation features on a particular person or a particular group from pronunciation features identified in many sessions. The system can also provide interfaces for a user to create general features manually according to the features extracted in each session The features reflect the more general characteristics of a particular user or a particular group. The system continues to capture user's pronunciation in various sessions and provides interfaces for a user to do comparison, analyze, and modify.

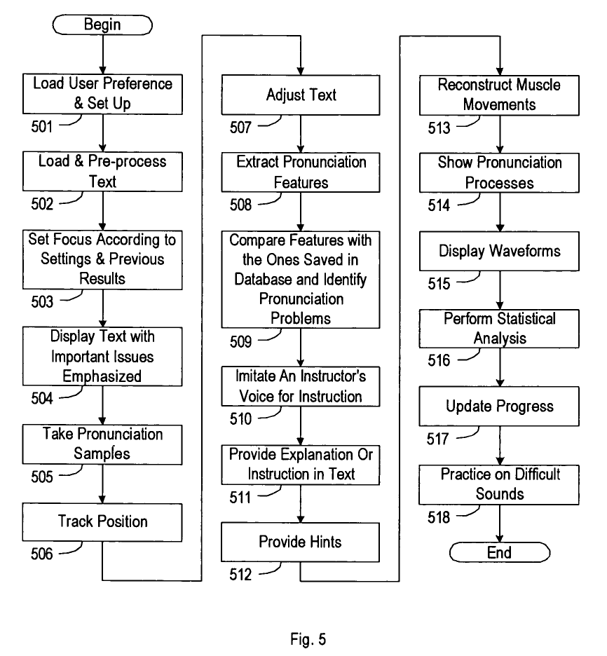

FIG. 5 shows an exemplary flowchart of helping a user to practice pronunciation. First, the system can have various training materials pre-prepared for helping different categories of users on different pronunciation issues. After having loaded a particular training material, the system can extract information about various pronunciation issues such as the sounds, tone, stress, linking sounds, etc. The system also provides interfaces for a user to load text into the system, identify sounds, suggests proper pitches, marks regular stresses, and labels various difficult sounds according to a dictionary, tone patterns, previous results, and statistical analysis. Second, the system displays text and marks sounds, tones, and stresses with corresponding symbols, icons, or fonts. Third, the system captures pronunciation samples, tracks user's reading positions, and adjusts texts correspondingly. Fourth, the system extracts features from the pronunciation samples, compares them with the ones in database, reconstructs the pronunciation process, displays related portions of the pronunciation process from one or more different aspects, and shows various assistant diagrams. Fifth, the system can concentrate in a group the words or the sentences containing sounds that a user has difficulty to pronounce correctly, provide opportunity for a user to practice these sounds repeatedly, and offer various helps in forms of diagrams, verbal instructions, symbol representations, and text explanations.

At step 501, the system loads the information about the preferences of a user into the system and provides interfaces for the user to set up various aspects. There can be one or more ways to represent a sound, its related pronunciation movements, its initial positions and shapes, and its analysis results in different domains. Different people or same people at different stages may prefer different forms even for a same issue. Some people may want the system to display the front view of a correct pronunciation, some people may want to system to display the cut-section view of a wrong pronunciation, and some people may just want the system to display symbolic indications of both a wrong pronunciation and the corresponding correct pronunciation. This step lets a user set up the focus of pronunciation training and how the system should provide help. Depending on settings, when the system identifies a pronunciation problem, the system can provide helps immediately but without stopping practicing, the system can also stop practicing, provide helps, and then let user continue, or the system can further collect all pronunciation problems and provide various helps together after a session

At step 502, the system loads text information into the system and preprocesses the text information. There are two kinds of texts. One is training materials preinstalled in the system, which are pre-created by pronunciation experts for providing user's repeatedly and intensive pronunciation exercise. These training materials not only contain text information as a usual text document does, but also contain expert's general opinions, the correct pronunciation of letters or letter clusters, waveforms, pronunciation features, muscle movements, diagrams, suggested pitches, proper stresses, verbal explanations, written interpretations, symbols, icons, pronunciation instructions, fonts, etc. For the need of different categories of users or a same user at different stages, these training materials can further have several different layers with each layer for helping a particular category of people on their pronunciation trainings or a user at a different training stage. According to user's preferences, settings, and previous results, the system extracts corresponding information from training materials. The expert's general opinions, which usually are in form of various rules or scripts that the system understands, can help the system to provide more flexible processes and specific helps to a particular user. According to user's particular situations and the opinions of experts, the system can create information to help a user on a specific issue.

Another is texts needed by a user to perform pronunciation exercise. Besides doing exercise according to training materials, the system can also provide interfaces for a user to select text-based documents to practice. A user may want to practice on a specific text document for exercising on a speech, an interview, or a speech test of a foreign language. After having loaded the text document, the system identifies the pronunciation of each word in the document and links letters and letter clusters to corresponding pronunciations according to a dictionary or pronunciation rules created from a dictionary.

The system can identify various sounds, stresses, tones, and linking sounds. A training material may have each sound, stress, tone, reduced sound, and linking sound marked already. The system can also check a dictionary for words, identify correct sounds for pronouncing words or letters, follow tone patterns for identifying proper tones with some variations induced by predefined procedures, and emphasize major pronunciation issues set up by preference or according to previous results saved in the system for a particular person. The system can further provide necessary interfaces to build connections between a sound or a word and corresponding muscle movements, waveforms, or diagrams. In addition, the system can judge if there are linking sounds, how to generate linking sound according to linguistic rules concerning linking sounds, etc.

At step 503, the system sets focus on a pronunciation practice. The system can accomplish this according to the major pronunciation issues of the training material used for a particular type of people, user's preference, user settings, and the problems identified in previous exercises about a particular user. The system can also provide interfaces for a user to set pronunciation focus. The pronunciation of a particular sound, the pronunciation of particular type of sounds, tones, stresses, linking sounds, reduced sounds, etc. are examples of possible major pronunciation issues. The system can also search for the profile of a particular user from its database to decide what problems the user may have and what the user should focus. Instead of displaying too much information or pursuing on too many targets, this step will help a user to focus on some specific issues and to make progress gradually.

At step 504, the system displays text with important issues emphasized. According to the practice focus and the preferred display format, the system indicates major pronunciation issues properly. For example, the system can display the letters or letter clusters that have a sound difficult for a user to pronounce in a different font, provide a pronunciation indication, show a corresponding diagram below a word, on page margin, or in another window, provide corresponding hints, remind key requirements on pronunciation organs, and show pronunciation diagrams.

At step 505, the system takes pronunciation samples from a user. The pronunciation samples can include bother verbal samples and non-verbal samples. The system will use these samples to extract pronunciation features, judge if a pronunciation is right, and reconstruct a pronunciation process.

At step 506, the system tracks the current position at which that a user is reading. There are three ways to do that. First, the system can identify the contents from the pronunciation samples and then compare them with the contents in the text document. Second, the system can track user's eye movement. According to where the eyes focus, when the eyes returns to left side from right side, or to top from bottom, and the contents on monitor, the system can judge what the user is reading now. Third, the system can also provide interface for a user to indicate what the user is reading. The system can use each one of them. The system can also use all of them simultaneously and then make a joint decision.

At step 507, the system adjusts the displayed texts. Usually, the system will display the text in middle of a window, or at a predefined display position. Depending on settings, the system can also update the text when a user wants to get to the next page or go back to previous page of the text document.

At step 508, the system analyzes the pronunciation samples and extracts pronunciation features from the pronunciation samples. The system can use various technologies such as statistical analysis and pattern recognition and perform various analyses in time domain, in a transform domain, or in both domains.

At step 509, the system compares the extracted pronunciation features with the ones saved in database and then finds out the pronunciation problems according to predefined procedures. These procedures are designed to simulate the process of how experts identify problems from the differences between corresponding pronunciation features. The system finds the pronunciation feature deviations between the pronunciation features extracted from the pronunciation samples of a user and the pronunciation features extracted from the pronunciation samples of a native speaker. Next, the system makes a joint decision on the possible pronunciation problems of the user according to the pronunciation feature deviations. Then, the system quantifies the pronunciation feature deviations and provides corresponding explanations, instructions, hints in oral form or in text form, or hints in both forms to help the user to make improvement. One can sort the pronunciation feature deviations according to an instance, a sound, a word, a sentence, a section, and a group.

At step 510, the system provides verbal instruction for helping a user to pronounce. Whether the system will provide verbal instruction and which instructor's voice the system will depend on settings. There are two types of verbal instructions. The first one is a pre-reminder for a sound to be pronounced and the second one is a post-reminder for a sound just pronounced. The pre-reminder reminds a user the correct way to pronounce a sound, the key requirements for pronounce a sound, and the mistake to be voided. The post-reminder tells a user if the user should pronounce a sound with more stress, how a pronunciation organ should act, etc.

At step 511, the system provides explanation or instruction in text. Whether the system will provide explanations or instructions in text, and how the system will display them depend on settings. There are also two types of reminder, one is pre-reminder and one is post-reminder.

At step 512, the system provides symbols and icons for various sounds. Instead of providing full explanation or instructions, the system can display symbols or icons for various commonly encountered pronunciation issues. Again, whether the system will provide representation in symbols or icons depends on settings.

At step 513, the system reconstructs the muscle movements of various organs according to the extracted features and the relations between pronunciation features and muscle movements. The system provides necessary interfaces for experts, teachers, or users to create these relations according to statistical analysis, linguistic analysis, acoustic analysis, etc. and save these relations in its database. The system can figure out the muscle movements of a user's pronunciation from captured image and the relations between pronunciation features and muscle movements. The system can also build the muscle movements of a reference pronunciation according to the relations or the muscle movements for particular sounds, words, and sentences saved in the system.

At step 514, the system shows the pronunciation process of a user. The system can also display the pronunciation process of a reference pronunciation. How to show these pronunciation processes and from which aspects to show them depend on settings.

At step 515, the system can display the waveforms of user's pronunciation and a reference pronunciation. These waveforms can be in original domain, which usually is in time domain, or in any transform domains.

At step 516, the system performs various statistical analyses on user's pronunciation samples, mistakes made, etc. to generate a new profile about user's pronunciation on trouble sounds, how good for pronouncing a particular sound, etc.

At step 517, the system compares the results of a user at different moments to update the information about the user and find out the progress of the user. The system can also display the progress in proper diagrams. The system can further provide proper encourage messages saved in database for predefined situations.

At step 518, the system provides interfaces for a user to work on difficult sounds. Depending on settings, the system can let a user to practice a difficult sound, a difficult word, or a difficult sentence several times immediately after the system detects a trouble sound for the user. The system can collect all the difficult sounds, difficult words, or difficult sentences, sort them properly, and then let the user to work on them repeatedly. During practice, the system continues to provide a user proper feedbacks, helps, and directions. The system can also provide interfaces for a user to adjust speed and practice at normal speed or slow motion The system can further provide interfaces for a user to change pronunciation parameters and modify muscle movements, show a pronunciation process from various aspects, and use various diagrams to illustrate how pronunciation organs work.

What is claimed is:

1. A system for helping a user to notice pronunciation organs and their muscle movements in producing a sound, to examine a pronunciation process associated with said sound, and to pronounce said sound correctly, said system containing relations between pronunciation features and corresponding muscle movements, wherein each of said pronunciation features consist of components for distinguishing different pronunciations, wherein said relations reveal connection between said pronunciation features and corresponding muscle movements, said system comprises:
means for collecting pronunciation samples of said sound from said user;
means for extracting pronunciation features from said pronunciation samples to generate extracted pronunciation features;
means for linking said extracted pronunciation features with corresponding muscle movements of said pronunciation organs according to said relations;
means for reconstructing and displaying said pronunciation process associated with said sound by a sequence of muscle movements of various pronunciation organs according to said extracted pronunciation features; and
whereby said system can identify various pronunciation features of said user on said sound, identify various muscle movements of said user on said sound, tie said pronunciation movements to corresponding said pronunciation features, and reproduce said pronunciation process.

2. The system in claim 1, said system taking said pronunciation samples from said sound in an original domain, wherein said means for extracting pronunciation features from said pronunciation samples comprise a means selected from a group consisting of:
means for performing analysis on said pronunciation samples in said original domain to obtain pronunciation features in said original domain, wherein said pronunciation samples comprise verbal samples and image samples;
means for performing transform on said pronunciation samples to obtain transformed pronunciation samples in a transform domain and means for performing analysis on said transformed pronunciation samples to obtain pronunciation features in said transform domain; and
means for performing analysis on muscle movements of said pronunciation organs.

3. The system in claim 1, said system further comprising means selected from a group consisting of:
a first means for recovering contents associated with said pronunciation samples to helps said system produce said extracted pronunciation features and regenerate said sound;
a second means for making use of results of previous pronunciation training sessions of said user to help said system provide progress indication and identify pronunciation problems for said user;
a third means for making use of preferences set up by said user to help said system to focus on various major issues particular to said user; and
a fourth means for making use of information provided by an expert for pronunciation problems particular to said user to help said system to identify said pronunciation problems and provide instruction for said user to make improvements, said expert being one selected from a group consisting of a software package, a teacher, and a pronunciation professional.

4. The system in claim 1, said system further comprising means for displaying articles selected from a group consisting of said pronunciation samples, said extracted pronunciation features, and said pronunciation process by diagrams, wherein said mean for displaying articles deploys a representation method selected from a group consisting of:
means for displaying from various aspects by one diagram then another diagram;
means for displaying an article by pre-selected diagrams simultaneously;
means for synchronizing said pre-selected diagrams;
means for zooming into a diagram;
means for zooming out from a diagram;
means for displaying from one direction;
means for displaying from a plurality of directions;
means for displaying invisible characters by different colors, line patterns, and weights; and
means for displaying in slow speed, normal speed, and rapid speed.

5. The system in claim 1, said system further comprising means for reducing noise and interference, and making important features prominent, wherein said means is a means selected from a group consisting of:
means for simplifying said pronunciation samples by removing trivial details according to information collected from training;
means for reducing noise in said pronunciation samples by employing proper filter;
means for reducing interference by making use of interference canceling technology; and
means for specifying and modifying said pronunciation samples,
whereby said system executing each of above means both automatically and interactively by following predefined procedures and by providing interface respectively.

6. The system in claim 1, said system further comprising:
means for displaying said pronunciation features; and
means for providing verbal explanations, text elaborations, and graphical indications on said extracted pronunciation features with different colors, different patterns, and different weights for different pronunciation features,
whereby said system can display said pronunciation features in a domain selected from a group consisting of original domains and transform domains;
whereby said system can display said extracted pronunciation features together with corresponding said pronunciation samples; and
whereby said system can display said pronunciation features in a fashion selected from a group consisting of natural fashion and artificial fashion.

7. The system in claim 1, said system further comprising means for comparing pronunciation features between said two pronunciations and means for showing differences between two pronunciations, wherein said two pronunciations can be ones selected from current pronunciation, previous pronunciations, and those saved in said system, said means for showing differences between two pronunciations comprising of means selected from a group consisting of:
means for marking different pronunciation by one selected from a group consisting of different color, different pattern, and different weights;
means for providing one selected from a group consisting of verbal explanations, text elaboration, and graphical indications on said differences;
means for showing shapes and positions of pronunciation organs, their changes, and their differences of each different pronunciation;
means for displaying pronunciation features by a manner selected from a group consisting of original domains, transform domains, and diagrams particular to pronunciation features; and
means for displaying pronunciation process of each of said pronunciations.

8. The system in claim 1, further comprising means for said user to modify said pronunciation samples and examine corresponding pronunciations from various aspects and means for regenerating sounds according to modified pronunciation samples, wherein said means for said user to modify said pronunciation samples and examine pronunciations from various aspects comprises of means selected from a group consisting of:
means for providing interface for said user to modify said pronunciation samples directly;
means for providing interface for said user to specify various attributes associated with said pronunciation samples, wherein said attributes include pitch, volume, duration, pace, and tone;
means for providing interface for said user to specify features in an original domain;
means for providing interface for said user to specify features in a transform domain;
means for providing interface for said user to specify muscle movements and modify muscle movements to generate modified muscle movements;
means for building a hearing model and generating parameters for said hearing model;
means for obtaining internal pronunciation samples from external pronunciation samples through said hearing models;
means for analyzing said internal pronunciation samples and comparing said internal pronunciation samples and said external pronunciation samples; and
means for displaying difference among original sound, modified sound and ones saved in said system, between said pronunciation samples and said modified pronunciation samples, between said extracted pronunciation features and said modified pronunciation features, and between said muscle movements and said modified muscle movements.

9. A system for building correlation between pronunciation features and muscle movements of various pronunciation organs, comprising:
means for collecting pronunciation samples from a performer;
means for extracting pronunciation features from said pronunciation samples, wherein said pronunciation features consist of components for distinguishing different pronunciations;
means for identifying muscle movements; and
means for linking said muscle movements with said pronunciation features.

10. The system in claim 9, wherein said means for extracting pronunciation features from said pronunciation samples comprise a means selected from a group consisting of:
means for performing analysis on said pronunciation samples in an original domain to obtain pronunciation features in said original domain;
means for performing transform on said pronunciation samples to obtain transformed pronunciation samples in a transform domain and means for performing analysis on said transformed pronunciation samples to obtain pronunciation features in said transform domain; and
means for performing analysis on said muscle movements of various pronunciation organs,
whereby said pronunciation samples comprise verbal samples and image samples.

11. The system in claim 9, said system further comprising means for an expert to define new features and means for reducing noise and interference, and making important features prominent, wherein said means for reducing noise and interference comprises a means selected from a group consisting of:
means for simplifying said pronunciation samples by removing trivial details according to information collected from training;
means for reducing noise in said pronunciation samples by employing proper filter;
means for reducing interference by making use of interference canceling technology; and
means for specifying and modifying said pronunciation samples,
whereby said system can perform above operations both automatically and interactively by following predefined procedures and by providing interfaces respectively.

12. The system in claim 9, further comprising means for rebuilding said pronunciation process, means for capturing feedback from an expert, and means for removing trivial features, wherein said means for rebuilding said pronunciation process comprises a means selected from a group consisting of:
means for regenerating sound according to said pronunciation features, related pronunciation parameters, and identified contents; and
means for building pronunciation models and creating procedures to find out related pronunciation parameters.

13. The system in claim 9, said system further comprising a means for displaying articles selected from a group consisting of said pronunciation samples, said pronunciation features, and said pronunciation process by diagrams, wherein said mean for displaying articles deploys means selected from a group consisting of:
means for displaying from various aspects by one pre-selected diagram then another pre-selected diagram;
means for displaying by pre-selected diagrams simultaneously;
means for synchronizing said pre-selected diagrams;
means for zooming into a diagram;
means for zooming out from a diagram;
means for displaying from one direction;
means for displaying from a plurality of directions;
means for displaying invisible characters by one selected from a group consisting of different colors, line patterns, and weights; and
means for displaying in slow speed, normal speed, and rapid speed.

14. The system in claim 9, further comprise:
means for providing interface for an expert to specify algorithms;
means for providing interface for said expert to build procedures to recognize various features;
means for providing interface for said expert to create various pronunciation models;
means for providing interface for said expert to create artificial features; and
means for providing interface for said expert to create artificial sounds to generate variety of samples.

15. The system in claim 9, further comprise a means selected from a group consisting of:
means for finding out pronunciation features for a person;
means for finding out pronunciation features for a group of people;
means for finding out difference among pronunciation features for people in said group;
means for finding out common pronunciation features between two groups; and
means for finding out different pronunciation features between two groups.

16. A system for helping a user to make pronunciation practice according to a document, said system having contained exemplary pronunciation features, exemplary pronunciation problems, exemplary pronunciation feature deviations, exemplary pronunciation problems, pronunciation feature identification procedures, and first type of relations between said exemplary pronunciation feature deviation and corresponding exemplary pronunciation problems, said system comprising:
means for preprocessing said document to recognize items selected from a group consisting of sounds, stresses, and pitches;
means for identifying important pronunciation issues associated with said user;
means for displaying said document with said important pronunciation issues emphasized;
means for taking pronunciation samples from said user while said user is reading said document;
means for extracting pronunciation features from said pronunciation samples according to said pronunciation feature identification procedures;
means for comparing said user pronunciation features with said exemplary pronunciation features and generating instance pronunciation deviations;
means for identifying instance exemplary pronunciation deviations that are close to said instance pronunciation deviations;
means for identifying instance exemplary pronunciation problems according to said instance exemplary pronunciation deviations and said first type of relations; and
means for providing feedback according to said instance exemplary pronunciation problems.

17. The system in claim 16, said system further comprising:
means for setting pronunciation practice focus according to user's setting up, previous results, general rules in said system, and expert's opinions coming with said document;
means for tracking marking position, said marking position pointing to current unit on said document that said user is reading at;
means for adjusting displayed portion of said document according to said marking position;
means for identifying instance exemplary pronunciation problems according to said instance exemplary pronunciation deviations and said first type of relations;
means for pinpointing instance pronunciation problems by combining said instance exemplary pronunciation problems according to said instance pronunciation deviations;
means for providing said user to manipulate pronunciation samples, pronunciation process, and pronunciation organs;
means for displaying a pronunciation process from a viewing point selected from a group consisting of front of face, side of face, inside of mouth, with a particular pronunciation organ only, and with several pronunciation organs together;
means for displaying plurality of diagrams with a symbol representing a corresponding pronunciation organ for a same pronunciation process and synchronizing said plurality of diagrams;
means for displaying plurality of waveforms in a domain selected from a group selected from a time domain and a transform domain; and
means for providing interface for said user to adjust and modify pronunciation samples and to generate modified pronunciation samples for examining how a pronunciation will change from various aspects.

18. The system in claim 16, wherein said means for preprocessing said document comprises means selected from a group consisting of means for extracting information about sounds, stress syllables, said sub-stress syllables, non-stress syllables, linking sounds, reducing sounds, and pitches from said document pre-saved in said system with major pronunciation issues marked at different layers for different user and for a user at different stages, means for identifying sounds, stress syllables, said sub-stress syllables, non-stress syllables, linking sounds, and reducing sounds according to a dictionary, means for suggesting proper tones according to pitch patterns saved in said system, and means for identifying linking sounds according to linking sound cluster rules saved in said system; and
wherein said means for displaying said document with said important pronunciation issues emphasized comprises means for identifying pronunciation problems associated with said user by a method selected from a first group consisting of making use of previous results on pronunciation problems for said user and extracting corresponding settings of said user, means for indicating said important pronunciation issues by a scheme selected from a second group consisting of linking letters with corresponding sounds, making letters in different fonts, and adding extra symbols, and means for reminding said user key requirements for generating a particular sound.

19. The system in claim 16, said system containing second relations between said exemplary pronunciation features and muscle movements of pronunciation organs, wherein said means for extracting pronunciation features comprises a means selected from a group consisting of
means for simulating experts to find said pronunciation features from said pronunciation samples in original domain;
means for making transform on said user pronunciation samples to generate transformed pronunciation samples;
means for simulating experts to find said pronunciation features from said transformed pronunciation samples in a transform domain;
means for simulating experts to identify facial expression by various pattern recognition techniques; and
means for simulating experts to identify muscle movement of various pronunciation organs from images and said second relations.

20. The system in claim 16, wherein said means for providing feedback comprises a means selected from a group consisting of
means for imitating oral instructions;
means for providing written explanations;
means for proving pronunciation hints;
means for reconstructing pronunciation processes and showing said pronunciation processes;
means for displaying waveforms in various domains;
means for performing statistical analysis and showing user progress;
means for finding difficult sounds and other pronunciation issues;
means for letting said user to concentrate and practice on said difficult sounds; and
means for displaying a pronunciation process of a particular pronunciation organ from a particular aspect.
